(19) United States
(12) Patent Application Publication
(10) Pub. No.: US 2014/0233621 A1
(43) Pub. Date: Aug. 21, 2014

(54) GSM/EDGE TRANSMIT POWER CALIBRATION AND CHARACTERIZED DIGITAL PREDISTORTION CALIBRATION USING MULTI-BAND MULTI-CHANNEL MULTI-CHAIN SWEEP

(71) Applicant: QUALCOMM Incorporated, San Diego, CA (US)

(72) Inventors: Sudarsan KRISHNAN, San Diego, CA (US); Andre V. IZOTOV, San Diego, CA (US); Michael R. HUGHES, San Diego, CA (US); Abhishek Kumar AGRAWAL, San Diego, CA (US); Satheesha B. RANGEGOWDA, San Diego, CA (US)

(73) Assignee: QUALCOMM Incorporated, San Diego, CA (US)

(21) Appl. No.: 14/040,377

(22) Filed: Sep. 27, 2013

Related U.S. Application Data
(60) Provisional application No. 61/765,505, filed on Feb. 15, 2013.

(51) Int. Cl. H04B 17/00

(52) U.S. Cl. CPC H04B 17/001
USPC 375/224

(57) ABSTRACT

A method and apparatus for characterized pre-distortion calibration is provided. The method begins with the selection of a number of devices to be characterized. The number of devices selected may be a subset of a larger group of devices. The selected number of devices is then characterized. The method avoids characterizing the large group of devices. The apparatus includes a processor for performing pre-distortion calibration, a processor for averaging curves for each RF gain index on each channel, and a non-volatile memory.

### CLAIM OF PRIORITY UNDER 35 U.S.C. §119

The present application for patent claims priority to Provisional Application No. 61/765,505, entitled “GSM/EDGE TX PWR CALIBRATION AND CHARACTERIZED DPD CALIBRATION USING MULTI-BAND MULTI-CHANNEL MULTI-CHAIN SWEEP” filed Feb. 15, 2013, and assigned to the assignee hereof and hereby expressly incorporated by reference herein.

### BACKGROUND

1. Field

The present disclosure relates generally to wireless communication system. More specifically the present disclosure related to methods and apparatus for characterized digital pre-distortion calibration of a GSM/EDGE power amplifier using multi-band multi-channel multi-chain sweeps.

2. Background

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

As use of mobile devices grows, so does the need to manufacture and test new devices in an efficient manner. Linear power amplifiers, such as those used for EDGE mode, require careful pre-distortion calibration in order to operate the power amplifier. Global System for Mobile (GSM) calibration and testing is an expensive proposition. These tests demand significant time at the factory for the calibration process. Typically, such calibration and testing requires measurement of multiple values throughout the testing process. These tests require significant amounts of time to conduct. In some cases, operating values are selected which may be less than optimum but which require less testing time to determine may be used. In these cases, operating values such as EDGE mode current are less than optimum. In addition, the process only becomes more expensive and difficult as mote transmit and receive chains are added. This is especially true for solutions such as Dual Sim/Dual Active (DSDA) devices.

There is a need in the art for methods and apparatus for reducing the time and cost associated with GSM calibration and test.

### SUMMARY

Embodiments disclosed herein provide a method for characterized pre-distortion calibration. The method comprises the steps of: selecting a number of devices for characterizing, wherein the number of devices selected is a subset of a group of devices; characterizing that selected subset of devices; and then calibrating the group of devices based on the characterization of the selected number of devices.

A further embodiment provides an apparatus for characterized pre-distortion calibration. The apparatus includes a processor for performing pre-distortion calibration and a processor for averaging curves for each radio frequency (RF) gain index on each channel, as well as a non-volatile memory.

A still further embodiment provides an apparatus for characterized pre-distortion calibration that incorporates means for selecting a number of devices for characterizing, wherein the number of devices selected is a subset of a group of devices. The apparatus also incorporates means for characterizing the selected number of devices and means for calibrating the group of devices based on the characterization of the selected number of devices.

An additional embodiment provides a computer-readable non-transitory storage medium containing instructions. The instructions cause a processor to perform the steps of: selecting a number of devices for characterizing, wherein the number of devices selected is a subset of a group of devices; characterizing the selected number of devices; and calibrating the group of devices based on the characterization of the selected number of devices.

### BRIEF DESCRIPTION OF THE DRAWINGS

FIG. 1 illustrates one configuration of a wireless communication system, in accordance with certain embodiments of the disclosure.

FIG. 2 illustrates a block diagram of an example of electronic components capable of transmitting in accordance with certain embodiments of the disclosure.

FIG. 3 depicts the test table according to an embodiment.

FIG. 4 is a flow diagram of a method for transmit power calibration and characterized digital predistortion (DPD) in a GSM system using a multi-band multi-channel multi-chain sweep according to an embodiment.

FIG. 5 is a flow diagram of a method for characterized pre-distortion calibration of GSM/EDGE devices, according to an embodiment.

FIG. 6 illustrates the time division duplexing (TDD) used in testing a DS/DA device, according to an embodiment.

FIG. 7 shows the command header for a factory test mode (FTM) command according to an embodiment.

FIG. 8 depicts the frame payload according to an embodiment.

FIG. 9 illustrates the calibration time line for a channel, according to an embodiment.

FIG. 10 shows the relationships between the FTM command contents, frame payload, slot payload, slot operation, and operation payload, according to an embodiment.

FIG. 11 illustrates the relationships between the FTM response contents, response payload, result payload, result command and result value, according to an embodiment.

FIG. 12 is a block diagram illustrating one example of a system capable of transmitting after a test period to calibrate a power amplifier, according to embodiments of the disclosure.

FIG. 13 illustrates components of a wireless device according to embodiments of the disclosure.

FIG. 14 depicts various components that may be utilized in a wireless communication device.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

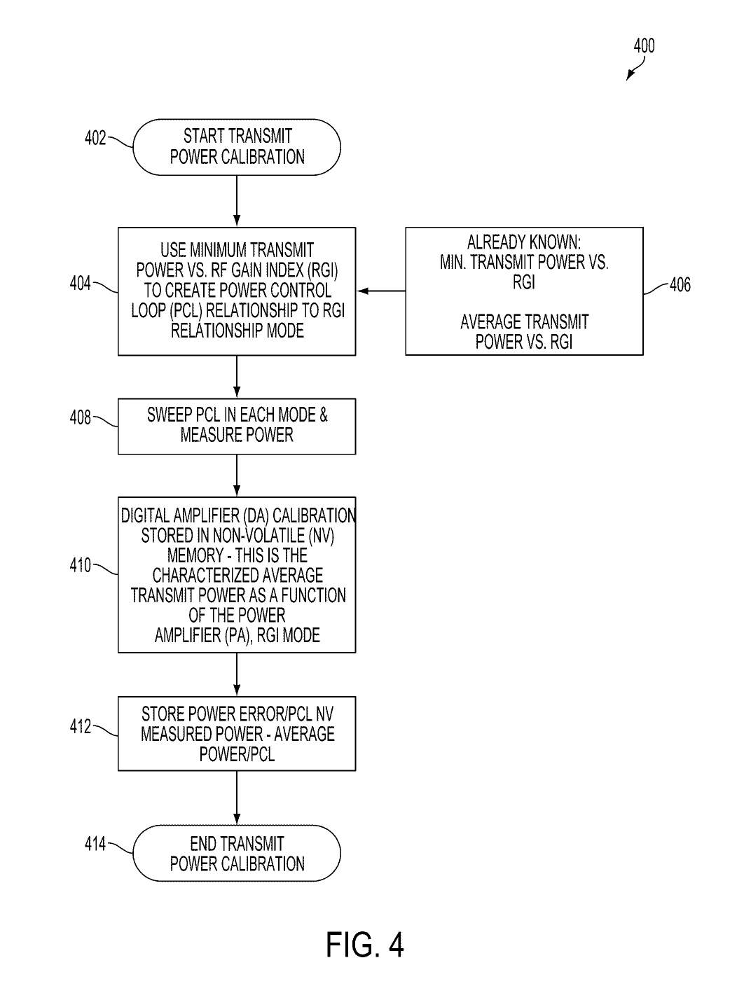

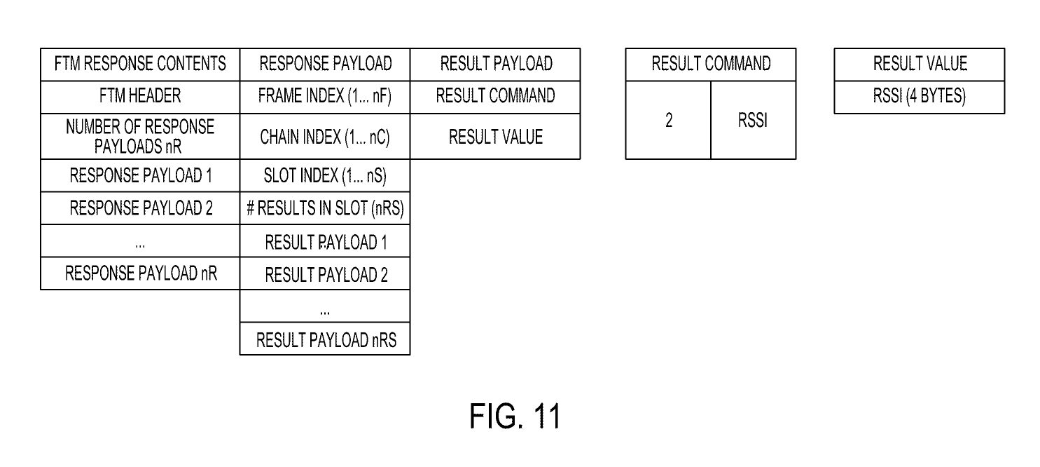

Further, it should be appreciated that modules and/or other appropriate means for performing the methods and techniques described herein, such as those illustrated by FIGS. 4 and 11, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

Calibration of GSM transmit power and DPD calibration can be difficult and time consuming, involving many steps and repetitive test runs. Increasingly, chipsets used in GSM devices incorporate on-board test capabilities to facilitate factory testing. However, in many cases, the calibration process requires that many values be repeatedly measured. Standards may require testing up to 32 known power levels, with an output recorded for testing at each power level. Traditionally such calibration testing used standard specified timing.

Calibration testing typically requires that a band first be selected. The next step required that all channels in the band be tested. A sweep through the frequencies of the channel is performed and the testing then moves on to the next sequence. The sequence is repeated until all channels in the selected band have been calibrated and tested. The process is repeated for each band the phone may operate on. Calibrating each band requires testing three channels, each with four power amplifier states. The RF gain index requires testing all 32 channels, from 0 to 31, for each power amplifier range. It is also required that all channels be tested for each power amplifier state. Additional testing may be required, depending on the baseband modulation type, such as GMSK, of 8 Phase Shift Keyed (8-PSK). The total test run requires 768 separate tests, as the current calibration scheme for digital amplifier (DA) calibration characterizes the entire device. The maximum characterized table may include 256 entries. The process may be complicated further if multiple transmit and receive chains are involved.

Amplifiers may have a linear range and a non-linear range. In order to avoid signal distortion, amplifiers may be used in the linear range. In the non-linear range, the signals may be subject to distortion due to amplitude to amplitude modulation and amplitude to phase modulation. This may be caused by the ratio of input power to output power may not be constant when the amplifier is operated in the non-linear range. As the input signal amplitude increases, a disproportionate increase in the output power may occur. This may be referred to as amplitude modulation to amplitude modulation (AMAM), since an unwanted additional amplitude modulation is experienced.

AMAM may be experienced up to a maximum output power at which point the input values may result in the same output values. When this occurs it may be known as compression, and may result in the signal being clipped. The signal may have square or sharp edges in the time domain, which implies that higher frequency components may be generated. This may cause out of band emissions in addition to the distortion of the amplified signal.

The output phase of the signal may not be constant at different amplitude levels of the input signal undergoing amplification. The amplified signal may experience a phase modulation as a function of the input amplitude. This relationship may not be constant, that is, the relationship may be non-linear. This may be referred to amplitude modulation to phase modulation (AMPM).

A power amplifier may be driver harder in order to obtain more efficiency from the power amplifier. Typically, operating a power amplifier at a higher efficiency comes at a price of amplitude and phase distortion of the input signal. Pre-distortion techniques may be used to correct these distortions. However, the power amplifier may have a memory effect. This memory effect means that the actual observed distortion depends on the nature of the waveform to be transmitted. This means that the AMAM or AMPM characteristics of the power amplifier may depend on the nature of the waveform of the input signal. It is desirable to measure the AMAM and AMPM characteristics of the power amplifier when a transmitter transmits a waveform similar to an actual transmit waveform. This testing is usually done during the manufacturing or assembly of the transmitter that includes the power amplifier. The power amplifier may amplify signals for GSM communication systems, EDGE systems, WCDMA systems, among others.

During testing the measured mean AMAM and AMPM characteristics of the power amplifier may be used to pre-distort the transmit waveform. The power amplifier may also be calibrated using an actual transmit signal, which enables pre-distortion techniques to be used. These pre-distortion techniques may vary depending on the system where the power amplifier will ultimately be used. Each system may have different specifications for the power amplifiers used on that system. By using an actual transmit signal to calibrate the power amplifier the same power amplifier may be used for each type of communication system.

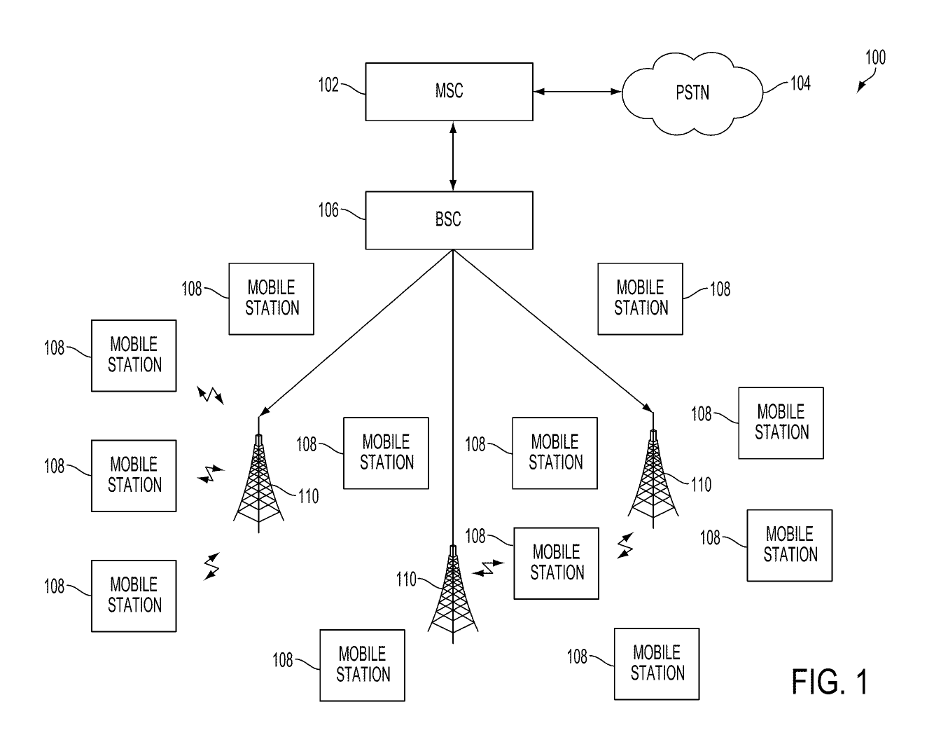

FIG. 1 illustrates a wireless system 100 that may include a plurality of mobile stations 108, a plurality of base stations 110, a base station controller (BSC) 106, and a mobile switching center (MSC) 102. The system 100 may be GSM, EDGE, WCDMA, CDMA, etc. the MSC 102 may be configured to interface with a public switched telephone network (PTSN) 104. The MSC may also be configured to interface with the BSC 106. There may be more than one BSC 106 in the system 100. Each base station 110 may include at least one sector (not shown), where each sector may have an omnidirectional antenna or an antenna pointed in a particular direction radially away from the base stations 110. Alternatively, each sector may include two antennas for diversity reception. Each base station 110 may be designed to support a plurality of frequency assignments. The intersection of a sector and a frequency assignment may be referred to as a channel. The mobile stations 108 may include cellular or portable communication system (PCS) telephones.

During operation of the cellular telephone system 100, the base stations 110 may receive sets of reverse link signals from sets of mobile stations 108. The mobile stations 108 may be involved in telephone calls or other communications. Each reverse link signal received by a given base station 110 may be processed within that base station 110. The resulting data may be forwarded to the BSC 106. The BSC 106 may provide call resource allocation and mobility management functionality including the orchestration of soft handoffs between base stations 110. The BSC 106 may also route the received data to the MSC 102, which provides additional routing services for interfacing with the PSTN 104. Similarly, the PTSN 104 may interface with the MSC 102, and the MSC 012 may interface with the BSC 106, which in turn may control the base stations 110 to transmit sets of forward link signals to sets of mobile stations 108.

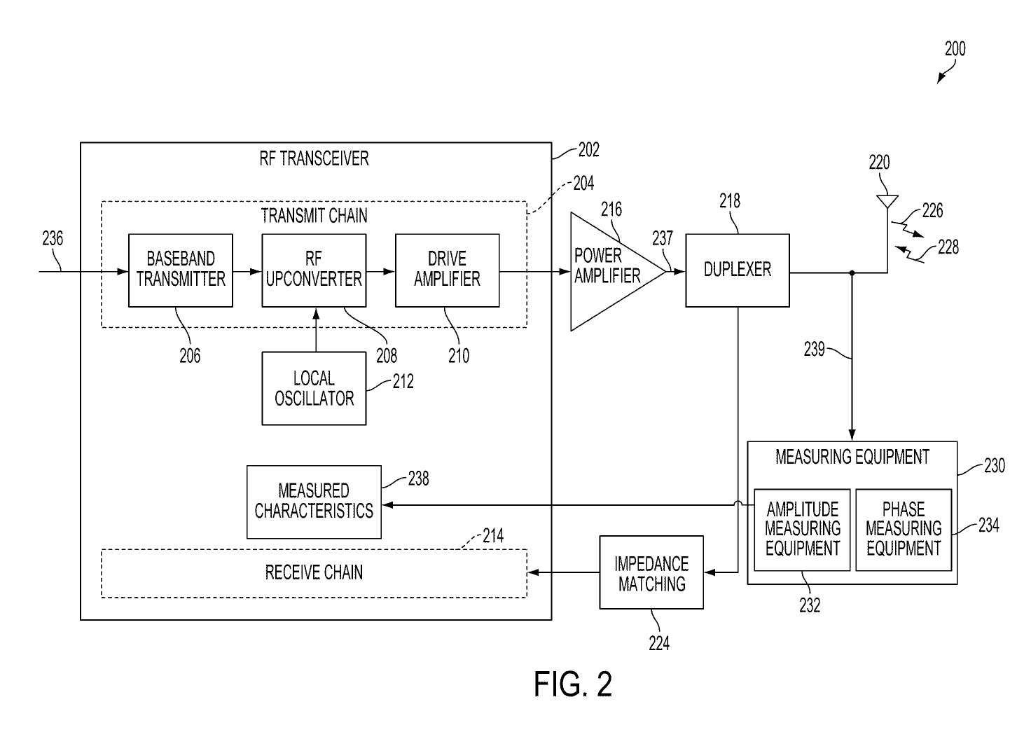

FIG. 2 is a block diagram illustrating one example of electronic components 200 capable of transmitting. The electronic components 200 may be part of a mobile station 108, a base station 110, or any other type of device that may transmit. The electronic components 200 may include a power amplifier 216. Tests may be conducted in order to optimize the performance and efficiency of the amplifier 216. In one scenario the tests may be conducted before the components 200 are marketed, that is, before an end user acquires the components 200. In one example, the configuration 200 may include a radio frequency (RF) transceiver 202. The transceiver 202 may transmit outgoing signals 226 and receive incoming signals 228 via an antenna 220. A transmit chain 204 may be used to process signals that are to be transmitted and a receive chain 214 may be implemented to process signals received by the transceiver 202. An incoming signal 228 may be processed by a duplexer 218 and impedance matching 224 of the incoming signal 228 may occur. The incoming signal 228 may then be processed by the receive chain 214.

In one configuration, the system 200 is tested in order to calibrate the power amplifier (PA) 216 and to optimize the efficiency of PA 216. A testing input signal 236 may be provided to a baseband transmitter 206. The baseband transmitter 206 may also include a filter (not shown) to filter out noise associated with the testing input signal 236. The testing input signal 236 may be upconverted to a high frequency signal by an RF upconverter 208. The upconverter 208 may be under the control of a local oscillator 212. A driver amplifier 210 may amplify the signal and the signal may pass through the PA 216.

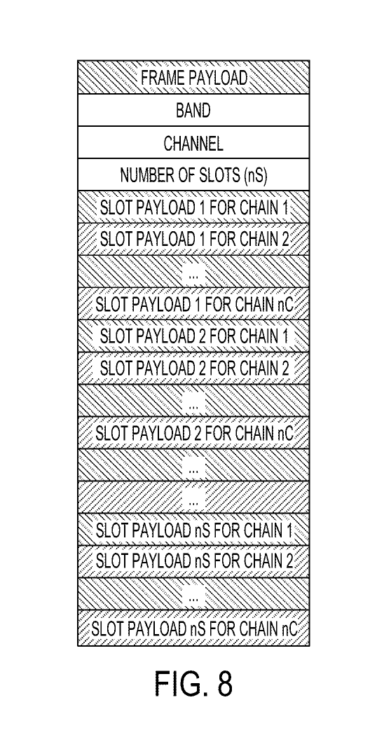

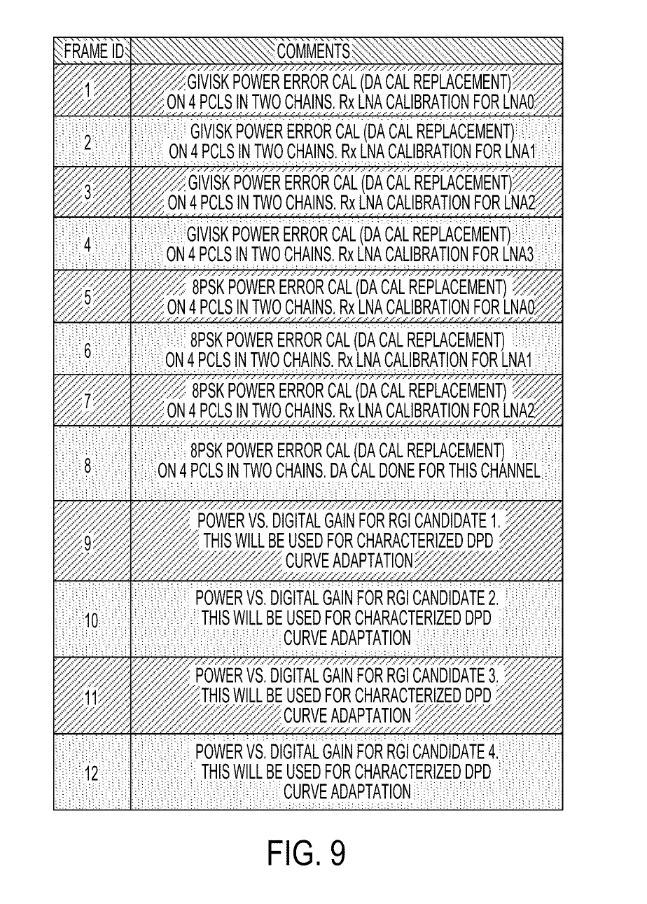

In one configuration, the testing input signal 236 may be fed through the transmit chain 204, into the PA 216, and PA output 237 may be passed through a duplexer 218. The duplexed signal 239 may be measured (rather than measuring the output signal 226 from the antenna 220). During the testing of PA 216, measuring equipment 230 may be connected to the output of the duplexer 218 (i.e., the duplexed signal 239). The equipment 230 may include amplitude measuring equipment or functionality 232 and phase measuring equipment or functionality 234. The measuring equipment 230 may be implemented by a computing device that includes a processor, memory, a display, communication interfaces, and the like. The block diagrams of FIGS. 8 and 9 illustrate these components in the context of a wireless device and a base station.

The measuring equipment 230 may implement the amplitude measuring functionality and the phase measuring functionality to measure the mean AMAM/AMPM characteristics of the PA output 237 after it has passed through the duplexer 218 (i.e., the duplexed signal 239). The measured characteristics 238 (e.g., mean AMAM/AMPM characteristics) may be used to implement pre-distortion techniques in the baseband transmitter 206 when the system 200 is in normal use (see FIG. 8). For example, if the components 200 were part of a mobile station 108, the pre-distortion techniques may be used in the baseband transmitter 206 during normal operation of the mobile station 108.

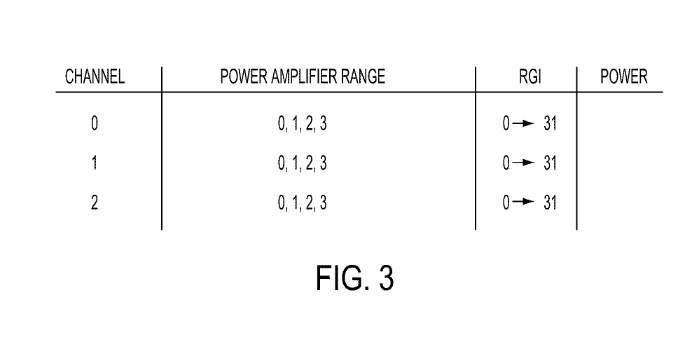

FIG. 3 illustrates a test table that may be used in the process of calibrating a GSM/EDGE device according to an embodiment. The embodiment described herein permits switching both band and channel on the fly to simplify testing. In the embodiment the DA is calibrated according to power error against power control level (PCL). This is in contrast to traditional power against RF gain index (RGI) testing described above. In effect, in the embodiment, a number of devices, such as 1000 out of one million are selected and the testing table of FIG. 3 is completed for each device. The table is thus the average of the tested devices. Completing the table of FIG. 3 is the first step in the process. Once the table is completed the data is stored on the device.

Actual operation of the device uses only a small subset of the 256 possible entries, typically the power levels designated either 0-15 or 5-19. With this selection, the maximum number of PCL entries is reduced to 16, (either 0-15 or 5-19)*2-32 entries.

Next, the phone or device is asked to transmit at a known power level. The embodiment may then ask the phone for the power level. The power level reported by the device is noted. This allows the error in the power control level to bee immediately seen. With this embodiment, the number of dimensions that are required to be tested has been reduced from 256 down to less than 32.

In the embodiment, new characterized data, both average and minimum is created. This provides for measured power against RGI across phones. For every target transmit power, it is possible to select the RGI that results in power greater than the target transmit power. This embodiment uses the minimum measured power against RGI table that was earlier stored on the phone.

Next, a transmit sweep is performed by PCL and mode. This is effectively a subset of RGI. The average measured power against RGI is stored on the phone, as is power errors per PCL. This may be stored in non-volatile storage. The phone may then be used in the mission mode with the usual temperature and frequency compensation.

FIG. 4 illustrates the steps of the method 400. At step 402 the transmit power calibration begins. The minimum transmit power against RGI value is used to create a power control loop (PCL) relationship to the RGI relationship mode in step 404. Step 406 provides already known inputs, including minimum transmit power against RGI, and average transmit power against RGI.

The PCL is then swept in each mode and power is measured in step 408. The digital amplifier calibration is stored in non-volatile memory in step 410. This is the characterized average transmit power as a function of the power amplifier and RGI mode. In step 412 the power error and PCL non-volatile measured power-average power/PCL are stored. The transmit power calibration ends at step 414.

A further embodiment provides for characterizing the device using amplitude modulation to amplitude modulation (AMAM) or amplitude modulation to phase modulation (AMPM) and then adapting the device using the metrics of power against digital gain.

During AMAM/AMPMA characterization, both the amplitude measuring functionality and the phase measuring functionality may be used to measure the mean AMAM/AMPM characteristics of the power amplifier output after it has passed through the duplexer. The measured mean AMAM/AMPM characteristics may then be used to implement pre-distortion techniques. In characterizing a set of phones the process may require that the AMAM maximum power, which defines the mapping between the output power and the baseband digital to analog converter (DAC) be adapted for each phone. The slope measurement of the AMAM slope correction may also be adapted for each phone. The averaging technique should be specified for both AMAM and AMPM. One such technique averages power with respect to DAC. The technique may be expanded to a family of curves based on the RGI. This family of curves may then be used to characterize and adapt using power against digital gain.

A method is provided that reduces calibration time by characterizing a set of phones and applying a characterized pre-distortion calibration to every phone. Specifically, this requires that the AMAM maximum power, which defines the mapping between the output power and the baseband digital to analog converter (DAC), be adapted for each UE. In addition, a slope measurement of the AMAM slope correction may be adapted for each UE. The averaging technique should be specified for both AMAM and AMPM. A first technique for averaging averages power with respect to DAC and also to average phase distortion with respect to DAC. These techniques may be expanded to become a family of curves based on the RGI.

Linear power amplifiers may be used in 8 phase shift keyed (8PSK) mode of communication. This mode requires that pre-distortion calibration be performed to ensure that lees current is consumed when operating in 8PSK mode. This pre-distortion calibration requires an additional eight seconds per band. This additional time results in additional cost.

The methods described below use average AMAM values across a product group of UEs. Some additional measurements are added during DA calibration. These additional measurements are made to ensure that DAC output is nearly equal to the maximum DAC of the characterized data.

The characterized AMAM/AMPM curves are applied to every UE. Once the pre-distortion RGI has been selected, the power difference between the EDGE_PD_Power for that RGI is computed and the characterized power difference is applied to the characterized AMAM maximum power.

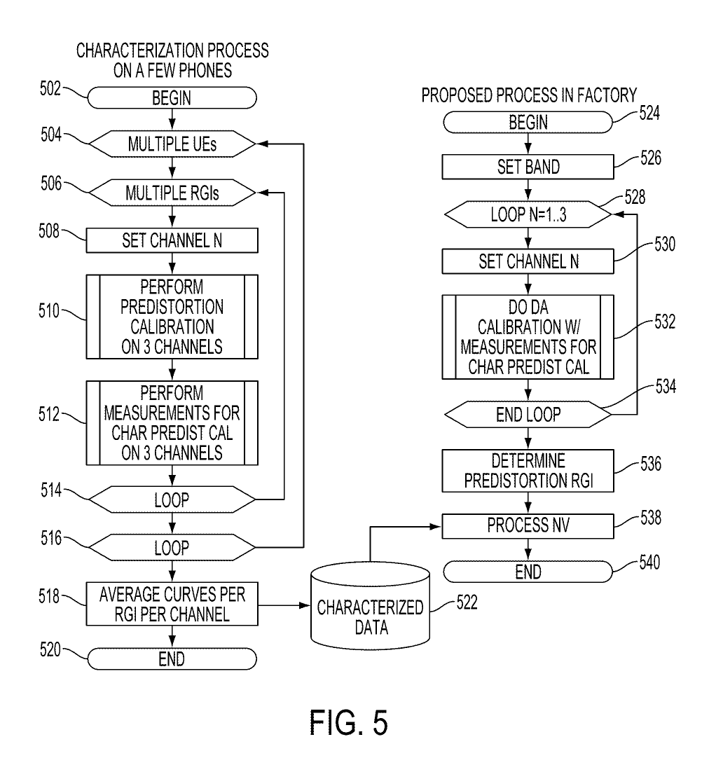

FIG. 5 illustrates the method steps of a method 500 of performing characterized pre-distortion calibration for a GSM/EDGE device. The method is performed in two phases, a first phase consisting of steps 502 through 520 that performs a characterization proves on a selected few UEs and a second process, consisting of steps 524 through 540 that is performed on the all the UEs in that factory prior to delivery.

The process 500, begins at step 502. In step 504 multiple UEs are selected to undergo the characterization process. The number of UEs selected for the characterization process may vary and should be carefully selected to provide the needed data points. For example, if a new model of UE is being tested, it may be desirable to select more UEs for characterization than if a current model phone is in production and the design is well known.

Once the multiple UEs have been selected, multiple reserve guard intervals (RGI) are selected. The RGI may be used with the optical cable OFDM transmissions and should be selected carefully. Various desired operating characteristics may influence the selection of the RGI. As part of step 506, multiple RGIs may be selected. In step 508 the channel to be tested, channel n, is set.

In step 510 pre-distortion calibration is performed on three channels. Once the pre-distortion calibration is performed, measurements for characterization prediction calibration are performed on the three selected channels in step 512. In step 514 this process is repeated for each selected RGI. In step 516 the process is repeated for each UE.

Once the necessary measurements have been made, the average curves for each RGI are computed for each channel. The characterization curves are stored with other characterized data in step 522. The data stored in step 522 is also made available for the factory process, as discussed further below.

The factory process that most UEs undergo begins at step 524. In step 526 a band for testing is set. The number of loop passes through the process is determined and set in step 528. The loop channel n is set in step 530. The digital amplifier (DA) calibration with the measurements obtained from the characterized pre-distortion calibration is performed in step 532 for each DA. The process continues through the selected number of loops. The loop process ends at step 534. In step 538 the envelope gain is process with input from the characterized data collected earlier during the characterization process at step 522 is input and the calibration process concludes at step 540.

The method provides a characterization technique for AMAM/AMPM with binning on an RGI basis, as the RGIs provide a means to separate amplifiers for specific calibration and processing. The method also provides maximum power adaptation for every UE and also provides AMAM slope adaptation for every UE.

The method may also implement slope correction to calibrate out the average AMAM slope in addition to the AMAM maximum power. This is done by measuring AMAM slope during characterization between the different envelope gains. The envelope gain settings are repeated during digital amplifier calibration. At that point the slope is determined and corrected if needed. A further embodiment provides for performing AMPM slope compensation in the same manner.

The envelope gain settings are stored in a non-volatile memory for use during both the characterization process and the factory process. The envelope gain settings that are stored in the non-volatile memory correspond to the DACs used during characterization. If the AMPM slope correction is needed a reference phase envelope gain value is stored in the non-volatile memory. As testing continues, the array of envelope gain values continue to be stored in the non-volatile memory.

When a power amplifier is driven to saturation both RF transceiver (RTR) and PA gain vary across parts, and as a result is not equal for every mobile device. It would be inaccurate to apply the same amount of pre-distortion to the baseband of every mobile unit. An embodiment described herein provides for a generic AMAM and AMPM curve as a function of power output (POUT) is created and a single measurement is made to map a given peak DAC value to a peak POUT value. Once the peak POUT for the individual device is known, the correct amount of pre-distortion may be extracted from the generic AMAM and AMPM curves.

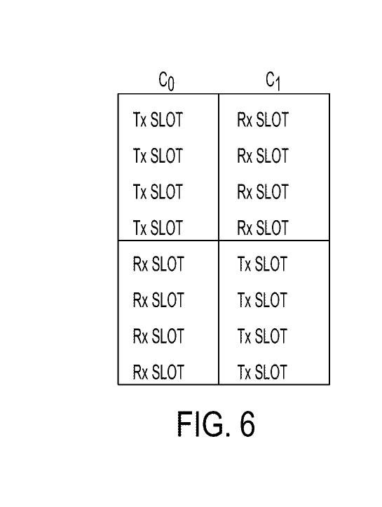

A further embodiment provides for calibration a dual simcard dual active (DS/DA) phone with no additional time required. The method includes using the characterized digital pre-distortion described above, and applying that characterization to each simcard in the device. Prior calibration methods required separate calibration for each of the two transmit and receive chains in the phone, doubling the time required for calibration. Using this embodiment, no additional time is required to calibrate the second phone. The two phones are time division duplexed (TDD) FIG. 6 illustrates the TDD described above.

A GSM frame consists of eight slots. The two transmit signals are combined in the test equipment. At this point the test equipment sees eight slots back to back as illustrated in FIG. 6, with four slots from the first phone and four slots from the second phone. As a result, the second phone may be measured without requiring any additional testing time.

In the embodiment, one command is sued to sweep in a multi-band multi-channel manner. The command header defines the number of frames and the number of slots being transmitted. The command header defines the number of frames and the number of slots being transmitted. The command may specify on a per-slot basis how the operation is to be performed. One example provides for transmitting four slots on the uplink chain and receiving for one slot. In using this embodiment, the characterized per-distortion RGI set is limited to four.

A still further embodiment provides for a factory test mode command. This command controls multiple transmit and receive chains. In addition, the command allows specifying a sweep of a band or channel on a slot-by-slot basis. Transmit operation allows for control of transmit PCL or transmit RGI with digital gain. The receive operation provides received signal strength indication for a given low noise amplifier (LAN) state.

In operation the measurement requirements should be met with the generalized packet radio frequency (GPRF) list mode transmit/receive. However, it should be noted that power may need to be corrected for filter or modulation on a per slot basis and power correction may need to be performed by terminal estimation (TE) or in a computer program.

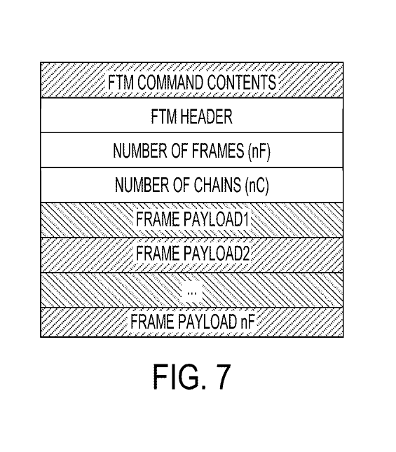

FIG. 7 shows the details of the FTM command. The FTM command is defined as a set of frame payloads. The header contains information on how many frames are involved while the chain information follows in the payload information.

FIG. 8 illustrates the frame payload. Each frame payload is made up of a set of slot payloads for each chain. The frame header indicates which band or channel on both chains as well as the number of slots that follow. Each slot has an associated operation and operation payload. The implementation may be a fixed length slot payload for ease of implementation. However, the operation payload may defined as four generic bytes.

The response packet may be expanded as was provided above for the slot payload. The response packet has a header that defines the number of responses, while each payload has an identifier that maps frame, chain, and slot. In addition, each result payload packet indicates a measurement command followed by a value.

FIG. 9 illustrates the calibration time line for a channel. In addition, a frame identifier provides specific information on the contents of each frame according to an embodiment.

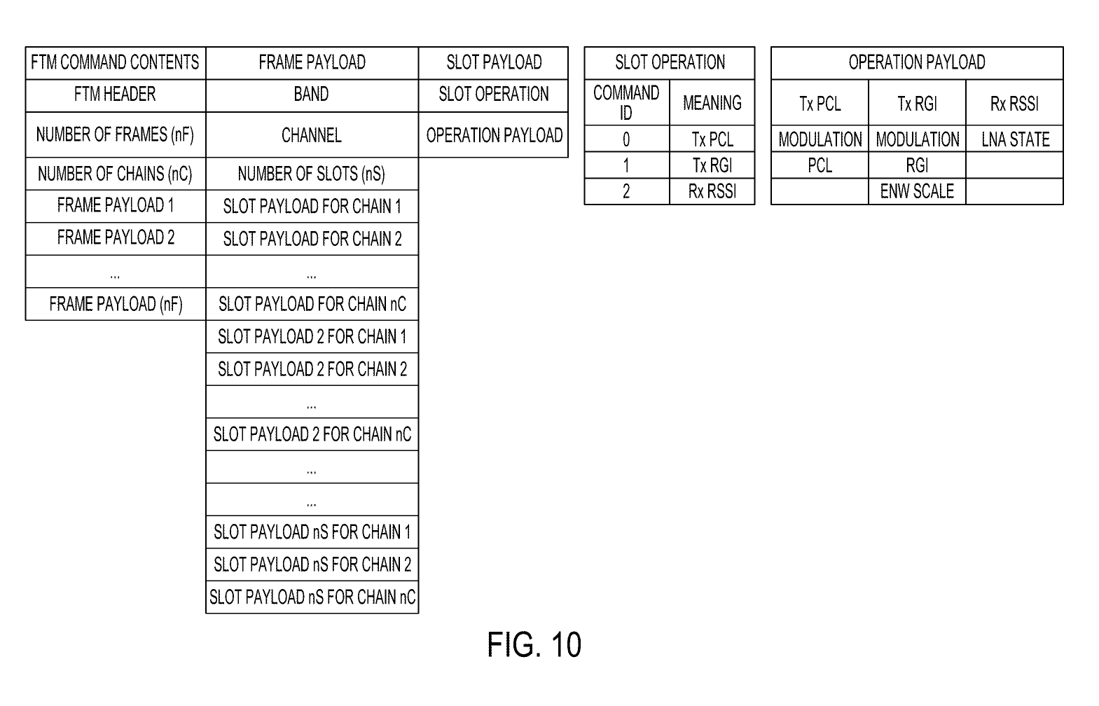

FIG. 10 depicts the relationship between the FTM command contents, frame payload, and slot payload. In addition, FIG. 10 provides the relationship of the slot operation commands and their meanings as well as the operation payload definitions.

FIG. 11 depicts the relationship between the FTM response contents, response payload, and result payload. In addition, FIG. 11 provides the relationship of the result command and the result value.

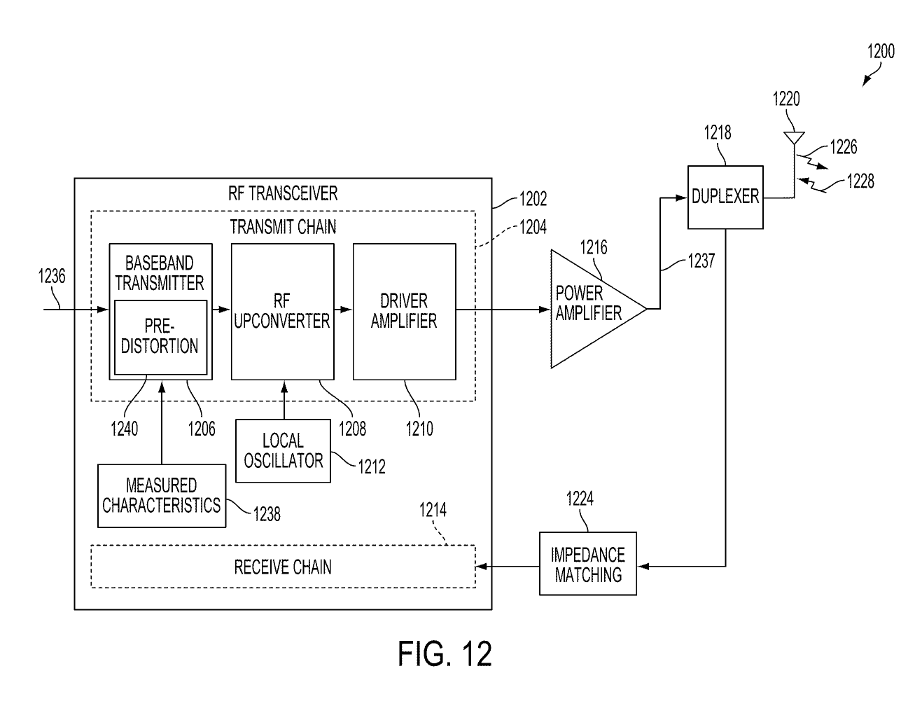

FIG. 12 is a block diagram depicting one example of a transmitting system 700 during normal operation. The system 1200 may include an RF transceiver 1202 for transmitting outgoing signals 1226 and receiving incoming signals 1228 via an antenna 1220. The RF transceiver 1202 includes a receive chain 1214 that receives the incoming signals 1228. For example, the incoming signals 1228 may be received by the antenna 1220 and processed by duplexer 1218. An impedance matching module 1224 may match the impedance of the incoming signals 1228. The receive chain 1214 may further process the incoming signal 1228.

A transmit signal 1236 may be processed by the transmit chain 1204 before being transmitted as an outgoing signal 1226. The transmit signal may be input to a baseband transmitter 1206 which is part of the transmit chain 1204. Pre-distortion techniques may be applied to the transmit signal 1236 at the baseband transmitter 1206. The pre-distortion techniques may be applied to the transmit signal 1236. The pre-distortion may cancel or otherwise compensate for distortion that is added to the signal at a PA 1216. The pre-distortion techniques may be determined based on the measured AMAM/AMPM characteristics that were characterized as described above as part of the testing procedure of a transmitter in system 1200.

After the signal is processed by the baseband transmitter 1206, it may be upconverted to a higher frequency signal by an RF upconverter 1208. The upconverter 1208 may be controlled by a local oscillator 1212. A driver amplifier 1210 may amplify the upconverted signal. In addition, the PA 1216 may further amplify the signal. Amplification of the signal by the PA 1216 may distort the signal. the pre-distortion previously applied to the signal may cancel or otherwise compensate for the distortion added at the PA 1216. An amplified signal 1237 may be processed by the duplexer 1218 and transmitted as a transmit signal 1226 to a receiving device via antenna 1220.

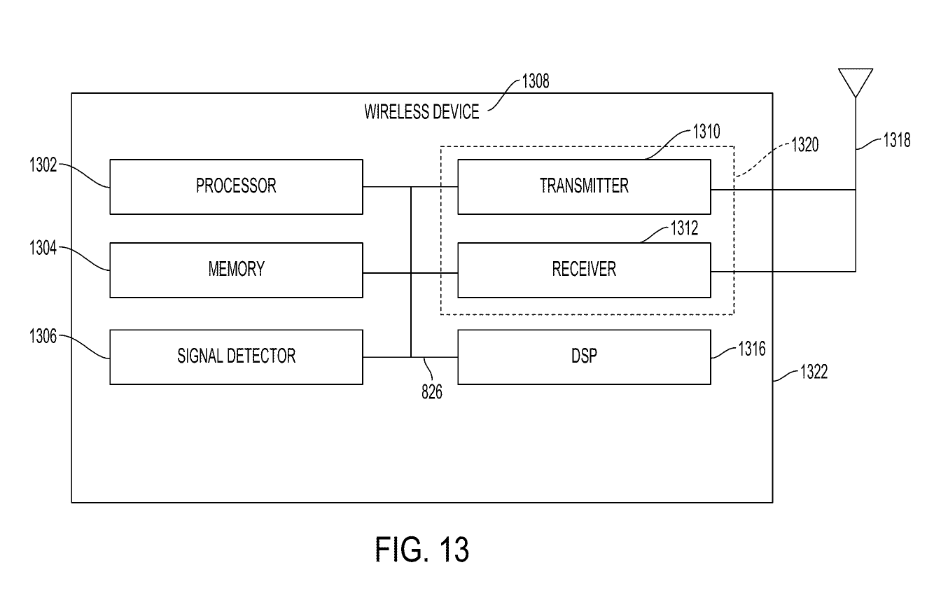

FIG. 13 illustrates various components that may be utilized in a wireless device 1308. The wireless device 1308 is an example of a device that may be used with the various systems and methods described herein. The wireless device 1308 may be a mobile station 108, a mobile telecommunications device, cellular telephone, handset, personal digital assistant (PDA), etc.

The wireless device 1308 may includes a processor 1302 which controls operation of the wireless device 1308. The processor 1302 may also be referred to as a central processing unit (CPU). Memory 1304, which may include both read-only memory (ROM) and random access memory (RAM) provides instructions and data to the processor 1302. A portion of the memory 1304 may also include non-volatile random access memory (NVRAM). The processor 1302 typically performs logical and arithmetic operations based on program instructions stored within the memory 1304. The instructions in the memory 804 may be executable to implement the methods described herein.

The wireless device 1308 may also include a housing 1322 that may include a transmitter 1310 and a receiver 1312 to allow transmission and reception of data between the wireless device 1308 and a remote location. The transmitter 1310 and receiver 1312 may be combined into a transceiver 1320. An antenna 1318 may be attached to the housing 1322 and electrically coupled to the transceiver 1320. The wireless device 1308 may also include (not shown) multiple transmitters, multiple receivers, multiple transceivers, and/or multiple antennas.

The wireless device 1308 may also include a signal detector 1306 that may be used to detect and quantify the level of signals received by the transceiver 1320. The signal detector 1306 may detect such signals as total energy, pilot energy per pseudonoise (PN) chips, power spectral density, and other signals. The wireless device 808 may also include a digital signal processor (DSP) 1316 for use in processing signals.

The various components of the wireless device 1308 may be coupled together by a bus system 1326 which may include a power bus, a control signal bus, and a status signal bus in addition to a data bus. However, for the sake of clarity, the various buses are illustrated in FIG. 13 as the bus system 1326.

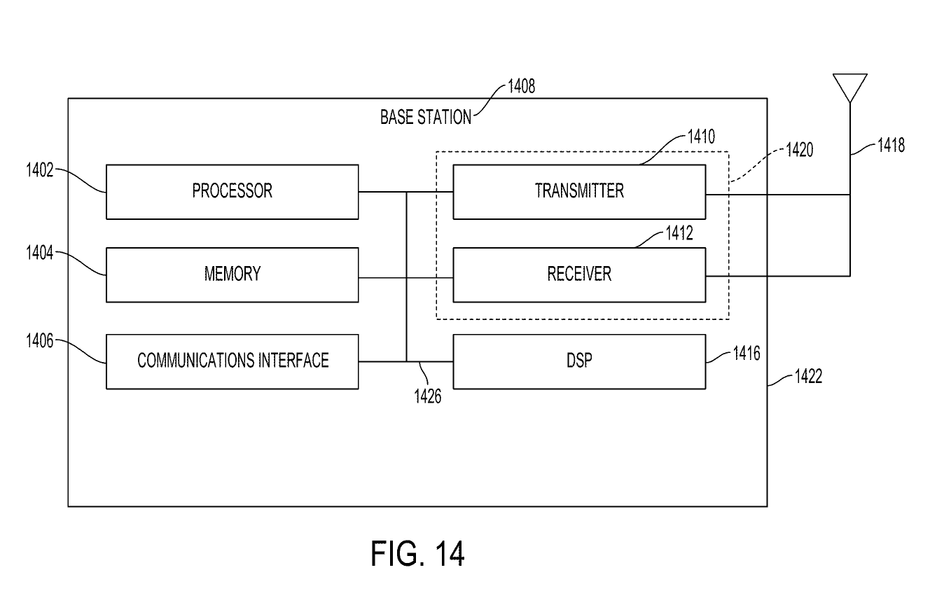

FIG. 14 is a block diagram of a base station 1408 in accordance with one example of the disclosed systems and methods. The base station 1408 is an example of a device that may be used with the various systems and methods described herein. Examples of different implementations of a base station 1408 include, but are not limited to, an evolved NodeB (eNB), a base station controller, a base station transceiver an access router, etc. The base station 1408 includes a transceiver 1420 that includes a transmitter 1410 and a receiver 1412. The transceiver 1420 may be coupled to an antenna 1418. The base station 1408 further includes a digital signal processor (DSP) 1414, a general purpose processor 1402, memory 1404, and a communication interface 1406. The various components of the base station 908 may be included within a housing 1422.

The processor 1402 may control operation of the base station 1408. The processor 1402 may also be referred to as a CPU. The memory 1404, which may include both read-only memory (ROM) and random access memory (RAM), provides instructions and data to the processor 1402. A portion of the memory 1414 may also include non-volatile random access memory (NVRAM). The memory 1404 may include any electronic component capable of storing electronic information, and may be embodied as ROM, RAM, magnetic disk storage media, optical storage media, flash memory, on-board memory included with the processor 902, EPROM memory, EEPROM memory, registers, a hard disk, a removable disk, a CD-ROM etc. The memory 1404 may store program instructions and other types of data. The program instructions may be executed by the processor 1402 to implement some or all of the methods disclosed herein.

In accordance with the disclosed systems and methods, the antenna 1418 may receive reverse link signals that have been transmitted from a nearby wireless device 1408. The antenna 1418 provides these received signals to the transceiver 1420 which filters and amplifies the signals. The signals are provided from the transceiver 1420 to the DSP 1414 and to the general purpose processor 1402 for demodulation, decoding, further filtering, etc.

The various components of the base station 1408 are coupled together by a bus system 1426 which may include a power bus, a control signal bus, and status signal bus in addition to a data bus. However, for the sake of clarity, the various buses are illustrated in FIG. 14 as the bus system 1426.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for characterized pre-distortion calibration, comprising:
selecting a number of devices for characterizing, wherein the number of devices selected is a subset of a group of devices;
characterizing the selected number of devices; and
calibrating the group of devices based on the characterization of the selected number of devices.

2. The method of claim 1, wherein characterization further comprises:
characterizing pre-distortion amplitude modulation to amplitude modulation curves across multiple parts;
selecting a digital to analog converter (DAC) value having a relationship to a maximum DAC value for all bands a device operates on; and
storing the selected DAC value.

3. The method of claim 1, wherein the calibration further comprises:
sweeping an RF gain index over a range;
defining an amplitude modulation to amplitude modulation (AMAM) curve for each tested device; and
averaging the AMAM curve across the tested devices.

4. The method of claim 1, wherein the calibration further comprises:
sweeping an RF gain index over a range;
defining an amplitude modulation to phase modulation (AMPM) curve for each tested device; and
averaging the AMPM curve across the tested devices.

5. The method of claim 1, wherein the calibration comprises calibrating each device using an AMAM averaged curve and an AMPM averaged curve.

6. The method of claim 1, wherein each device of the group of devices is measured on at least three channels per band.

7. An apparatus for characterized pre-distortion calibration, comprising:
a processor for performing pre-distortion calibration;
a processor for averaging curves for each RF gain index on each channel; and
a non-volatile memory.

8. An apparatus for characterized pre-distortion calibration, comprising:
means for selecting a number of devices for characterizing, wherein the number of devices selected is a subset of a group of devices;
means for characterizing the selected number of devices; and
means for calibrating the group of devices based on the characterization of the selected number of devices.

9. The apparatus of claim 8, wherein the apparatus further comprises:
means for characterizing, wherein the means for characterizing comprises:
means for characterizing pre-distortion amplitude modulation to amplitude modulation curves across multiple parts;
means for selecting a digital amplifier calibration (DAC) value having a relationship to a maximum DAC value for all bands a device operates on; and
means for storing the selected DAC value.

10. The apparatus of claim 8, wherein the means for calibration further comprises:
means for sweeping an RF gain index over a range;
means for defining an amplitude modulation to amplitude modulation (AMAM) curve for each tested device; and
means for averaging the AMAM curve across the tested devices.

11. The apparatus of claim 8, wherein the means for calibration further comprises:
means for sweeping an RF gain index over a range;
means for defining an amplitude modulation to amplitude modulation (AMAM) curve for each tested device; and
means for averaging the AMAM curve across the tested devices.

12. The apparatus of claim 8, wherein the means for calibration comprises means for calibrating each device using an AMAM averaged curve and an AMPM averaged curve.

13. A computer-readable non-transitory storage medium of claim 13, containing instructions, which when executed cause a processor to perform the steps of:
selecting a number of devices for characterizing, wherein the number of devices selected is a subset of a group of devices;
characterizing the selected number of devices; and
calibrating the group of devices based on the characterization of the selected number of devices.

14. The computer-readable non-transitory storage medium of claim 13, further comprising instructions for characterization that cause a processor to perform the steps of:
characterizing pre-distortion amplitude modulation to amplitude modulation curves across multiple parts;
selecting a digital amplifier calibration (DAC) value having a relationship to a maximum DAC value for all bands a device operates on; and
storing the selected DAC value.

15. The computer-readable non-transitory storage medium of claim 13, further comprising instructions for calibration further comprising:
sweeping an RF gain index over a range;
defining an amplitude modulation to amplitude modulation (AMAM) curve for each tested device; and
averaging the AMAM curve across the tested devices.

16. The computer-readable non-transitory storage medium of claim 13, further comprising instructions for:
sweeping an RF gain index over a range;
defining an amplitude modulation to phase modulation (AMPM) curve for each tested device; and
averaging the AMPM curve across the tested devices.

17. The computer-readable non-transitory storage medium of claim 13, further comprising instructions for calibration that the calibration comprises calibrating each device using an AMAM averaged curve and an AMPM averaged curve.
